(19) United States
(12) Patent Application Publication
(10) Pub. No.: US 2026/0123583 A1
(43) Pub. Date: May 7, 2026

(54) FEEDING DEVICE WITH COVER ELEMENTS, MOVABLE RELATIVE TO EACH OTHER, FOR COVERING A ROLLER RECESS

(71) Applicant: Maschinenfabrik Bernard Krone GmbH & Co. KG, Spelle (DE)

(72) Inventors: HENDRIK EVERS, Emsbüren (DE); HOLGER ENSINK, Wietmarschen (DE)

(21) Appl. No.: 19/371,671

(22) Filed: Oct. 28, 2025

(30) Foreign Application Priority Data
Nov. 7, 2024 (DE) 102024132521.6

(51) Int. Cl. A01D 57/02; A01D 43/08; A01D 57/26

(52) U.S. Cl. CPC A01D 57/02; A01D 43/08; A01D 57/26

(57) ABSTRACT

The present invention relates to a feed device (2) for a forage harvester. The feed device is formed to convey agricultural crops in a feed direction (ER) through a feed channel (4). The feed device comprises a frame device (40) which comprises at least one side wall (42) for laterally delimiting the feed channel (4). The feed device comprises at least two pairs of feed rollers (10, 20, 30), each comprising a rotatably mounted upper roller element (12, 22, 32) extending laterally through at least one roller recess (13, 23, 33) in the side walls (42) to delimit the feed channel, and a rotatably mounted lower roller element (14, 24, 34) and which are arranged offset from one another in the feed direction (ER). The feed device comprises a bearing arrangement (50) which is formed for such mounting of the upper roller elements (12, 22, 32) in such a way that they are movable in a vertical direction (HR). The feed device comprises a covering apparatus (60) which has at least one covering element (62, 64) which is movable relative to the frame device (40) by means of the bearing arrangement (50) for covering the at least one roller recess (13, 23, 33). According to the invention, the covering apparatus (60) comprises at least one intermediate covering element (66) for covering the at least one roller recess (13, 23, 33), which is movably mounted relative to the frame device (40) and relative to the covering element (62, 64) by means of the bearing arrangement (50).

### TECHNICAL FIELD

The invention relates to a feed device for a forage harvester. The feed device is formed to convey agricultural crops in a feed direction through a feed channel. The feed device has a frame device comprising at least one side wall for laterally delimiting the feed channel. The feed device furthermore has at least two pairs of feed rollers, each comprising a rotatably mounted upper roller element to delimit the feed channel, and a rotatably mounted lower roller element and which are arranged offset from one another in the feed direction. The upper roller elements extend laterally through at least one roller recess in the side wall. The feed device furthermore has a bearing arrangement which is formed for such mounting of the upper roller elements in such a way that they are movable at least partially in a vertical direction angled to the feed direction to vary a height of the feed channel relative to the frame device. The feed device furthermore has a covering apparatus which has at least one covering element which is movable relative to the frame device by means of the bearing arrangement for covering the at least one roller recess.

### BACKGROUND

Such a feed device is known from the prior art. In use, the feed device is used to draw the crop from a harvesting attachment coupled to the forage harvester into the forage harvester and feed it to a chopper drum. The variable height of the feed channel allows for the reliable conveyance of different quantities of crop, and in particular, to reliably feed the crop at different conveying speeds to achieve different cutting lengths, resulting in different thicknesses of the crop stream in the feed channel of the chopper drum.

The mobility of the upper roller elements requires roller recesses that have a larger cross-section than the part of the respective upper roller element located therein. This necessarily leaves through-openings between the feed channel and the area surrounding the side wall, through which part of the crop to be conveyed inadvertently escapes from the feed channel. To reduce this escape of crop, several covering elements of the covering apparatus are used, for example, according to DE 2 149 974 A1, one of which is assigned to each upper roller element in such a way that the covering elements move at least partially in the vertical direction with the respective upper roller element.

A disadvantage of the known feed device is that the roller recesses can only be inadequately covered by the covering apparatus. Despite the covering apparatus, a significant portion of the crop regularly escapes from the feed channel during operation. This leads, on the one hand, to considerable contamination of functional parts, and in particular bearings, and increases their risk of failure. On the other hand, the escape of the crop leads to a significant reduction in harvest yields. The described disadvantage is particularly pronounced when the upper roller elements have a large range of movement in the vertical direction, especially since the extension of the covering element opposite to the vertical direction is limited by the associated lower roller element. However, a large range of movement is becoming increasingly important, since, depending on the crop and its intended use, the feasibility of particularly short cutting lengths and, on the other hand, the feasibility of particularly long cutting lengths is required.

### SUMMARY

The object of the present invention is to provide a feed device by which contamination of functional parts and/or crop losses can be reliably prevented, particularly in the case of extensive mobility of the upper roller elements.

The object is achieved according to the invention in that the covering apparatus comprises at least one intermediate covering element for covering the at least one roller recess. The intermediate covering element is movably mounted relative to the frame device and relative to the covering element by means of the bearing arrangement.

Depending on the position of the bearing arrangement, the intermediate covering element enables the covering of a portion of the roller recess that is not covered or to be covered by the covering element. In particular, the bearing arrangement can react to where such a portion is created and, depending on the position of the bearing arrangement, the intermediate covering element can be positioned where necessary to prevent crop loss.

In use, the feed device forms the so-called feed of a forage harvester. When mounted, the feed device is preferably located between the front wheels in a front view of the forage harvester. The feed device is formed in particular for conveying maize, grass, and/or grain.

The frame device of the feed device is preferably formed to be rigid and immovable. The frame device of the feed device is preferably mounted in a fixed position on a frame of the forage harvester. The side wall is preferably formed by a side wall plate that extends flat, at least adjacent to the feed channel, both in the feed direction and in the vertical direction. The frame device preferably has two side walls, by means of which the feed channel is delimited on both sides and which are arranged in particular mirror-symmetrically to one another. Particularly preferably, the side walls, the pairs of feed rollers, in particular with the exception of a drive element for absorbing drive energy, and the covering apparatus are formed to be mirror-symmetrical, wherein only the one-sided formation is described below.

Each pair of feed rollers comprises an upper roller element that delimits the feed channel at the top and a lower roller element that delimits the feed channel at the bottom. The feed device preferably comprises two or three pairs of feed rollers. The upper roller elements and/or the lower roller elements preferably each have a feed roller arranged completely between the side walls in a transverse direction and at least one shaft element that protrudes laterally from the feed roller and extends through the roller recess, i.e. penetrates the shaft recess. The side wall has in particular one roller recess per upper roller element. The roller recesses are preferably continuous in the transverse direction and are preferably completely enclosed by the side wall. A drive element for rotating the respective upper roller element is arranged on the shaft element outside the feed channel. The transverse direction is oriented at a right angle to both the feed direction and the vertical direction and, in particular, parallel to the axes of rotation of the upper roller elements.

By means of the bearing arrangement, the upper roller elements can be spaced at different distances from the lower roller elements. This allows the height of the feed channel extending between the upper and lower roller elements to be varied. The mobility of the upper roller elements is such that they are at least partially movable in the vertical direction. This refers in particular to a movement independent of the rotation of the upper roller elements. This can be a purely translational movement at least partially, in particular exclusively, in the vertical direction or, for example, a pivoting movement with a movement component in the vertical direction. The vertical direction is preferably angled by more than 45°, particularly preferably by at least substantially 90°, to the feed direction and is directed away from the lower roller elements. The mobility of the upper roller elements is reversible in and counter to the vertical direction.

The covering element and/or the intermediate covering element are/is preferably formed from a continuous material that extends flat, such as a sheet metal. The continuous material particularly preferably extends substantially at a right angle to the transverse direction. The side wall, the covering element, and the intermediate covering element are arranged, regardless of the order and depending on the position of the bearing arrangement, at least partially stacked on top of one another in the transverse direction, with their mutually facing surfaces at least partially touching. ‘Covering’ means that when viewing the side wall in or counter to the transverse direction through the at least one roller recess, the covering element and/or the intermediate covering element can be seen.

While the covering element is preferably mounted in such a way that it moves at least partially in the vertical direction with one of the associated upper roller elements, the movement of the intermediate covering element that occurs during this movement deviates from the movement of the covering element. By means of the bearing arrangement, the intermediate covering element is preferably mechanically coupled to the covering element or the upper roller element. Alternatively or additionally, a sensor for monitoring the position of at least part of the bearing arrangement, the upper roller elements or the covering element is preferably provided. Particularly preferably, the position of the intermediate covering element is adjustable depending on the monitored position, in particular by means of a dedicated intermediate covering element actuator. The intermediate covering element actuator is preferably arranged between the frame device and the intermediate covering element. The intermediate covering element provides the possibility of reliably closing the at least one roller recess in different operating situations.

The bearing arrangement is preferably formed to move the intermediate covering element depending on a movement, in particular independent of the rotational movement, of at least one of the upper roller elements. This movement arises during operation, in particular solely from the rotation of the upper roller element and the thickness of the conveyed crop stream. The movement of the intermediate covering element is particularly preferably directed at least partially, in particular exclusively, in the vertical direction, wherein the movement can be part of a complex and not necessarily purely translational movement sequence. The movement of the upper roller element is particularly preferably directed at least partially in the vertical direction and/or parallel to the movement of the intermediate covering element. The movements are to be understood as relative movements with respect to the frame device. Alternatively, at least partially opposing movements of the intermediate covering element and the top roller element and/or a movement including a pivoting movement of the intermediate covering element are conceivable. The bearing arrangement is particularly designed for a forced movement or forced guidance of the intermediate covering element depending on the movement of the upper roller element.

The bearing arrangement is preferably formed to reduce the movement of the at least one upper roller element in such a way that, during operation, a movement of the at least one upper roller element by a first distance causes a movement of the intermediate covering element by a second distance which is smaller than the first distance. The distances are measured in particular in the same direction, preferably in the vertical direction. The first distance is in particular a distance travelled by the rotational axis of the upper roller element. The second distance refers to at least one specific point of the intermediate covering element. The bearing arrangement is in particular formed for reduction in such a way that, during operation, the second distance is greater than half as large as the first distance. As a result of the reduction described above, it is possible in a structurally simple and thus reliable manner to cover portions of the roller recess occurring both above and below the rotational axis of the respective upper roller element projecting through the roller recess, which cannot be covered by the covering element, by means of the intermediate cover element, in particular without the need for a counter-rotating movement or a rotational movement.

The bearing arrangement for mounting the intermediate covering element comprises a control arm arrangement having a first control arm, a second control arm, and a third control arm. The first control arm is arranged at one end on the frame device and at the other end on the second control arm. The third control arm is arranged at one end on the second control arm and at the other end on a part of the bearing arrangement on/in which at least one of the upper roller elements is rotatably mounted, preferably exclusively. The part is in particular a first rocker element. The intermediate covering element is arranged on the second control arm between the first control arm and the third control arm. The arrangements described above are preferably understood as pivotably moving bearings. The control arm arrangement allows the mobility described above of the intermediate covering element to be implemented particularly easily and reliably.

The intermediate covering element is preferably configured to cover a first roller recess, a second roller recess, and in particular a third roller recess. In particular, the covering apparatus has exactly one intermediate covering element per side wall, which is particularly preferably formed to cover all roller recesses located in the side wall. As a result of this, the design is further simplified.

The intermediate covering element preferably has at least one additional roller recess formed such that at least one of the upper roller elements is movable within the additional roller recess relative to the intermediate covering element at least in the vertical direction. Similar to the side wall having the roller recesses, the intermediate covering element has the additional roller recesses in order to, on the one hand, completely surround the upper roller elements and thus cover the roller recesses as best as possible and, on the other hand, to enable the relative movement of the upper roller elements relative to the intermediate covering element.

The intermediate covering element and/or the at least one covering element are/is arranged in the transverse direction at a right angle to the feed direction between the feed channel and the side wall. In particular, the intermediate covering element or the covering element bears directly against the side wall. The intermediate covering element is particularly preferably arranged in a transverse direction between the at least one covering element and the feed channel. In particular, if the intermediate covering element extends over several or all of the roller recesses, this design of the covering apparatus allows edges or projections adjacent to the feed channel, which can make it difficult to convey the crop in the feed direction, to be reduced to a minimum.

Preferably, the covering element is formed to cover at least two roller recesses. Alternatively or additionally, the covering apparatus comprises at least two covering elements. The covering apparatus particularly preferably has a first covering element for covering a first roller recess and a second covering element for covering a second roller recess and in particular a third roller recess. The second covering element preferably surrounds both the second upper roller element and the third upper roller element. The first covering element preferably has two connecting elements projecting in the transverse direction to fix its position on the rocker element. The above-described division of the covering apparatus achieves a particularly practical compromise between the best possible sealing of the roller recesses and a structurally simple design for the intended range of motion of the upper roller elements.

The bearing arrangement preferably has a guide arrangement for guiding the intermediate covering element in the vertical direction. The guide arrangement is designed to prevent, in particular, unintentional pivoting of the intermediate covering element about a pivot axis parallel to the transverse direction. The guide arrangement comprises at least one, in particular two, guide elements arranged on the additional element. The at least one guide element particularly preferably extends into or through an intermediate covering element recess in the side wall. On the side of the side wall facing away from the feed channel, at least one guide rail is arranged, which extends at least partially in the vertical direction and interacts with the at least one guide element during operation. The guide element has, in particular, a guide roller mounted rotatably relative to the intermediate covering element. The intermediate covering element recess is, in particular, an elongated hole extending longitudinally in the vertical direction, wherein the intermediate covering element recess is arranged in particular between two roller recesses. In this way, the intended movement of the intermediate covering element is ensured.

For mounting the upper roller elements, the bearing arrangement comprises at least the first rocker element on which the upper roller elements are rotatably mounted, preferably exclusively. The bearing arrangement preferably has a second rocker element which is arranged pivotably movably on the frame device and pivotably movably about a rocker pivot axis on the first rocker element. The second rocker element is arranged offset from the first rocker element, in particular in the feed direction. The pivoting mobility of the first rocker element and/or the second rocker element is preferably limited by at least one rubber buffer. The rocker pivot axis is formed, in particular, coaxially with a rotational axis of one of the upper roller elements. The at least one covering element is preferably arranged stationary relative to or on the first rocker element. The bearing arrangement formed with the two rocker elements results in at least some of the upper roller elements being movable in two different directions, again apart from their rotational movement, depending on how the pivoting movement of the rocker elements is combined. This allows for the best possible response to the crop and the desired cutting lengths.

A conducting element which is arranged in a fixed position relative to the frame device is preferably arranged between the feed channel and the at least one covering element and/or the feed channel and the intermediate covering element. The conducting element preferably extends between at least a part of the upper roller elements and at least a part of the lower roller elements in the feed direction. The conducting element extends in particular beyond a lower edge of the intermediate covering element. The conducting element extends in particular flat parallel to the side wall. The conducting element partially covers the covering apparatus from the inside, thereby significantly facilitating crop flow. To facilitate crop flow, the bearing arrangement is preferably arranged entirely outside the feed channel. The control arm arrangement is particularly preferably arranged between the first rocker element and the side wall.

The conducting element preferably has a transverse guide portion at a feed channel inlet, which, facing away from the feed channel, projects at least partially or completely in the transverse direction beyond the intermediate covering element, the at least one covering element and/or the side wall. The transverse guide portion makes it easier for the crop to enter the feed channel in that it cannot get caught on the movable front edges of the intermediate covering element, the covering element or at least part of the side wall. The intermediate covering element and/or the conducting element has/have at least one, in particular one per lower roller element, concave recess. Alternatively, in a simplified manner, at least one lower edge of the intermediate covering element along the lower roller elements is preferably formed at least in portions at least substantially straight, i.e. without concave recesses. At least a part of one of the lower roller elements is arranged, at least in one position of the bearing arrangement, within each concave recess. This way, the space available in the area of the lower roller elements is used in the best possible way and in favour of the optimal coverage of the roller recesses.

The problem is furthermore solved by a forage harvester with the feed device described above. In particular, a chopping drum equipped with blades for cutting the crop is connected to the feed device in the feed direction.

### BRIEF DESCRIPTION OF THE DRAWINGS

Further details and advantages of the invention can be seen from the schematically illustrated figures described below; in the figures:

FIG. 1 shows a feed device according to the invention in a perspective view,

FIG. 2 shows the feed device according to FIG. 1 in an exploded representation,

FIGS. 3a-3h show individual components of the feed device according to FIG. 1 in side views,

FIG. 4 shows the feed device according to FIG. 1 with a bearing arrangement in a central position in a side view,

FIG. 5 shows a part of the feed device according to FIG. 1 in a perspective view,

FIG. 6 shows the feed device according to FIG. 1 with the bearing arrangement in a lower position in a side view,

FIG. 7 shows the feed device according to FIG. 1 with the bearing arrangement in an upper position in a side view,

FIG. 8 shows the feed device according to FIG. 1 with the bearing arrangement in a further position in a side view.

### DETAILED DESCRIPTION

Components with similar or identical functions are provided with identical reference numerals. The features described below can also be combined differently than shown in the drawings to form developments according to the invention.

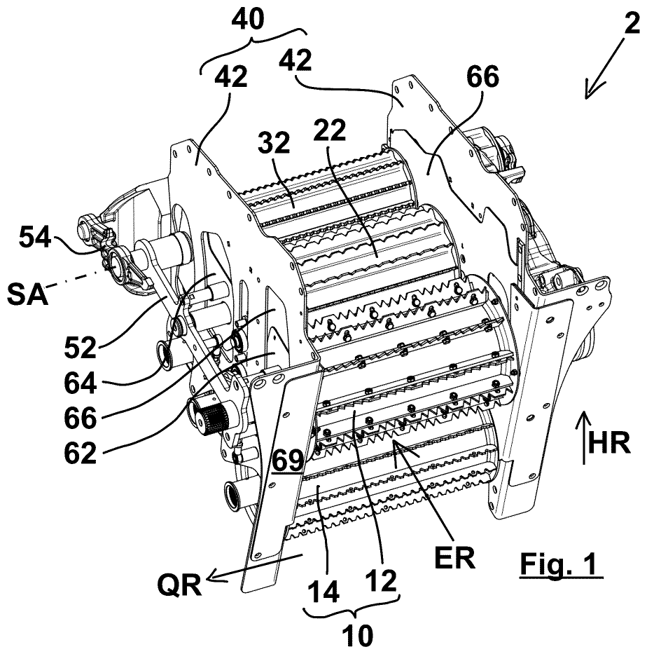

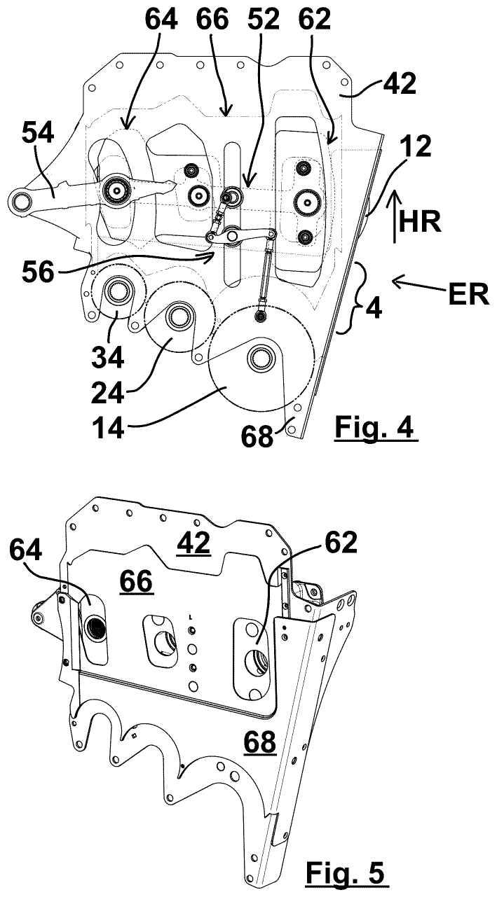

A feed device 2 according to the invention is represented in perspective in FIG. 1. The feed device 2 serves to convey agricultural crops in a feed direction ER and through a feed channel 4 (see FIG. 4 ff.), which extends, among other things, through a first upper roller element 12 and a first lower roller element 14, which together form a first pair of feed rollers 10. Following the pair of feed rollers 10 in the feed direction ER are two further pairs of feed rollers 20, 30, each of which has an upper roller element 22, 32 and a lower roller element 24, 34.

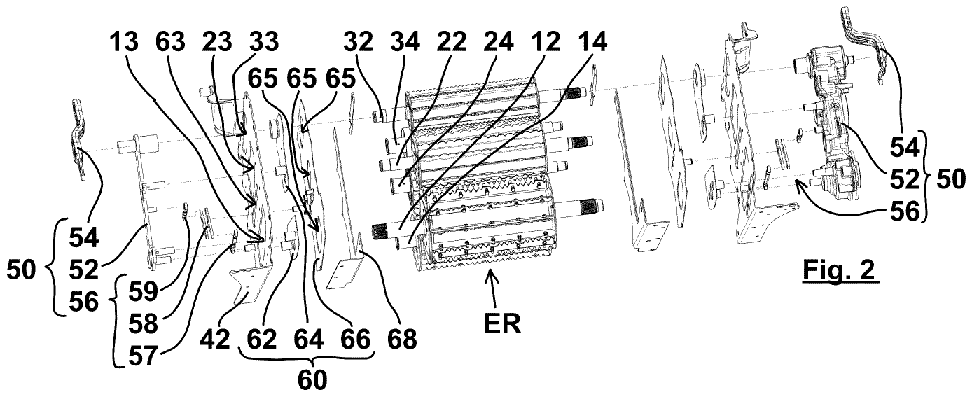

The feed channel 4 is delimited laterally by two side walls 42, which are enclosed by a frame device 40. The upper roller elements 12, 22, 32 each extend laterally through a roller recess 13, 23, 33 in the side walls 42. The roller recesses 13, 23, 33 (see in particular FIG. 2, which for the sake of clarity is only fully labelled on one side due to the essentially mirror-symmetrical design of the intake device, and 3c) are large enough to allow movement of the upper roller elements 12, 22, 32 in a vertical direction HR relative to the frame device 40 that is angled to the feed direction ER. A covering apparatus 60 serves to prevent crop material from escaping from the feed channel 4 through the roller recesses 13, 23, 33.

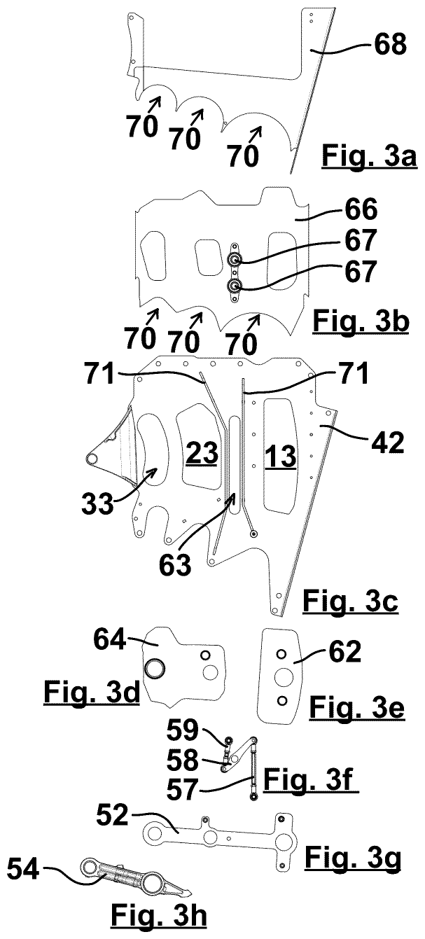

The covering apparatus 60 has a first covering element 62 and a second covering element 64 (see FIGS. 3e and 3d), which rest against the side wall 42 during operation. The first covering element 62 serves to cover a first of the roller recesses 13. The second covering element serves to cover both a second of the roller recesses 23 and a third of the roller recesses 33 during operation. In addition to the two covering elements 62, 64, the covering apparatus 60 comprises an intermediate covering element 66, which rests against the covering elements 62, 64 and is formed to cover all of the roller recesses 13, 23, 33. The intermediate covering element 66 has an additional roller recess 65 for each upper roller element 12, 22, 32.

A conducting element 68, which is stationary relative to the frame device 40, rests on the inside of the intermediate covering element 66. The conducting element 68 extends between the upper roller elements 12, 22, 32 and the lower roller elements 14, 24, 34 in the feed direction ER. The conducting element 68 has a transverse conducting portion 69 at a feed channel inlet, which protrudes in a transverse direction QR, facing away from the feed channel 4, over the intermediate covering element 66 and the first covering element 62. The intermediate covering element 66 and the conducting element 68 have a concave recess 70 for each lower roller element 14, 24, 34 (see FIGS. 3a and 3b).

A bearing arrangement 50 serves to mount the upper roller elements 12, 22, 32 and the components of the covering apparatus 60. The intermediate covering element 66 is mounted such that it is movably mounted relative to the frame device 40 and relative to the covering elements 62, 64. Two guide elements 67 are arranged on the intermediate covering element 66 (see FIG. 3b), which extend through an intermediate covering element recess 63 in the side wall 42. The guide elements 67 have guide rollers that roll along guide rails 71 arranged on the outside of the side wall 42 to guide the intermediate covering element 66 in the vertical direction HR (see FIG. 3c).

The bearing arrangement 50 comprises a first rocker element 52 and a second rocker element 54 for mounting the upper roller elements 12, 22, 32. The upper roller elements 12, 22, 32 are rotatably mounted on the first rocker element 52 (see FIG. 3g). The second rocker element (see FIG. 3h) is pivotably mounted on the frame device 40 and pivotally mounted about a rocker pivot axis SA on the first rocker element 52. The rocker pivot axis SA coincides with a rotational axis of the third upper roller element 32.

The bearing arrangement 50 is formed to force the intermediate covering element 66 to move in the vertical direction HR as a function of a movement of the first rocker element 52, at least partially in the vertical direction HR. The bearing arrangement 50 is formed, by means of a control arm arrangement 56, to reduce the movement of the first rocker element 52 to the intermediate covering element 66. The control arm arrangement 56 (see FIG. 3f) has a first control arm 57, a second control arm 58, and a third control arm 59. The first control arm 57 is arranged at one end on the frame device 40 and at the other end on the second control arm 58. The third control arm 59 is arranged at one end on the second control arm 58 and at the other end on the first rocker element 52, the intermediate covering element 66 is arranged between the first control arm 57 and the third control arm 59 on the second control arm 58. The movement is reduced by the control arm arrangement 56 such that, during operation, a movement of the first rocker element 52 by a first distance S22 in the vertical direction HR causes a movement of the intermediate covering element 66 by a second distance S66 in the vertical direction, which is smaller than the first distance S22, but greater than half as large as the first distance S22 (see FIG. 7).

FIG. 4 ff. illustrate different positions of the bearing arrangement 50. Hidden contours of some of the components of the feed device 2 are illustrated by dashed and dashed-dotted lines.

In FIG. 4, the bearing arrangement 50 is represented in a central position, in which the axes of rotation of the upper roller elements 12, 22, 32 are arranged approximately centrally within the roller recesses 13, 23, 33 with respect to the vertical direction HR, with the intermediate cover element 66 completely covering all roller recesses 13, 23, 33. FIG. 5 is a partial representation of the feed device 2 with the bearing arrangement 50 in the central position according to FIG. 4.

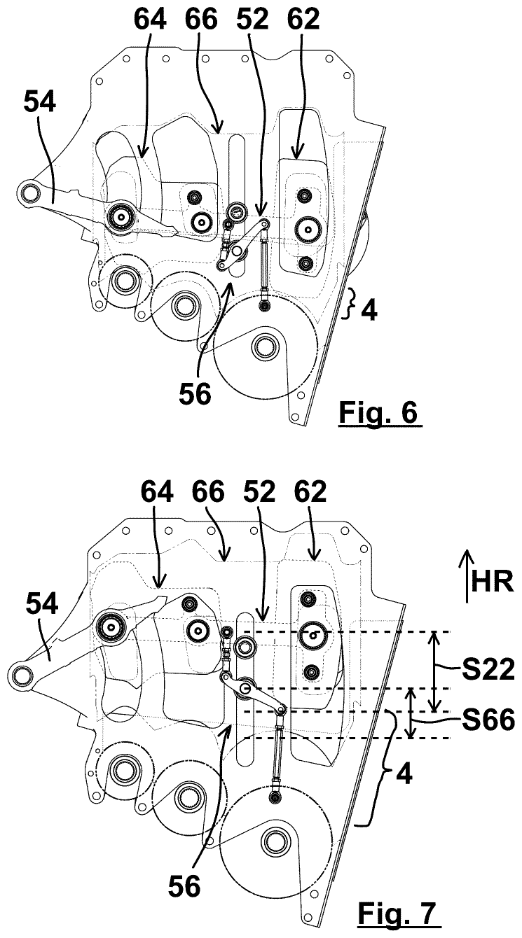

FIG. 6 represents the feed device 2 with the bearing arrangement 50 in a lower position in which the upper roller elements 12, 22, 32 and the lower roller elements 14, 24, 34 are closest to each other. The lower roller elements 14, 24, 34 extend partially into the recesses 70 of the intermediate covering element 66.

FIG. 7 represents the feed device 2 with the bearing arrangement 50 in an upper position, in which the upper roller elements 12, 22, 32 have a maximum distance from the lower roller elements 14, 24, 34. In the central position of the bearing arrangement 50 according to FIG. 4, the lower position of the bearing arrangement 50 according to FIG. 6 and the upper position of the bearing arrangement 50 according to FIG. 7, the first rocker element 52 is arranged at different heights, but is shown in the same orientation relative to the frame device 40.

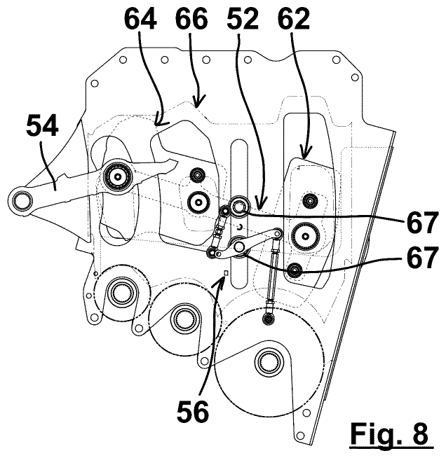

FIG. 8 represents the feed device 2 with the bearing arrangement 50 in a further position in which the first rocker element 52 is angled relative to the frame device 40, in contrast to its arrangement according to FIGS. 4, 6 and 7. It is noticeable that the first covering element 62 and the second covering element 64 are arranged in an equally angled manner, whereas the intermediate covering element 66 is movable relative to the frame device 40 exclusively in a translational manner in the vertical direction HR by the guide arrangement, of which no guide rail is shown.

1. A feed device (2) for a forage harvester, which is formed to convey agricultural crops in a feed direction (ER) through a feed channel (4) and comprises
a frame device (40) which comprises at least one side wall (42) for laterally delimiting the feed channel (4),
at least two pairs of feed rollers (10, 20, 30), each comprising a rotatably mounted upper roller element (12, 22, 32) extending laterally through at least one roller recess (13, 23, 33) in the side walls (42) to delimit the feed channel, and each comprising a rotatably mounted lower roller element (14, 24, 34), and which feed roller pairs (10, 20, 30) are arranged offset from one another in the feed direction (ER),
a bearing arrangement (50) which is formed for such mounting of the upper roller elements (12, 22, 32) in such a way that they are movable at least partially in a vertical direction (HR) angled to the feed direction (ER) to vary a height of the feed channel (4) relative to the frame device (40), and
a covering apparatus (60) which has at least one covering element (62, 64) which is movable relative to the frame device (40) by means of the bearing arrangement (50) for covering at least a part of the at least one roller recess (13, 23, 33), characterized in that the covering apparatus (60) comprises at least one intermediate covering element (66) for covering the at least one roller recess (13, 23, 33), which intermediate covering element (66) is movably mounted relative to the frame device (40) and relative to the covering element (62, 64) by means of the bearing arrangement (50).

2. The feed device according to claim 1, characterized in that the bearing arrangement (50) is formed to move the intermediate covering element (66) at least partially in the vertical direction (HR) depending on a movement of at least one of the upper roller elements (12, 22, 32) at least partially in the vertical direction (HR).

3. The feed device according to claim 1, characterized in that the bearing arrangement (50) is formed to reduce the movement of the at least one upper roller element (12, 22, 32) in such a way that, during operation, a movement of the at least one upper roller element (12, 22, 32) by a first distance (S22) causes a movement of the intermediate covering element (66) by a second distance (S66) which is smaller than the first distance (S22).

4. The feed device according to claim 1, characterized in that the bearing arrangement (50) is formed for reduction in such a way that, during operation, the second distance (S66) by which the intermediate covering element (66) is moved is greater than half as large as the first distance (S22) by which the at least one upper roller element (22) moves.

5. The feed device according to claim 1, characterized in that the bearing arrangement (50) for mounting the intermediate covering element (66) comprises a control arm arrangement (56) having a first control arm (57), a second control arm (58), and a third control arm (59), wherein the first control arm (57) is arranged at one end on the frame device (40) and at the other end on the second control arm (58), the third control arm (59) is arranged at one end on the second control arm (58) and at the other end on a rocker element (52) on which at least one of the upper roller elements (12, 22, 32) is rotatably mounted, and the intermediate covering element (66) is arranged on the second control arm (58) between the first control arm (57) and the third control arm (59).

6. The feed device according to claim 1, characterized in that the covering apparatus (60) has a sensor for monitoring the position of at least part of the bearing arrangement (50), at least one of the upper roller elements (12, 22, 32) and/or the covering element (62, 64), and has an actuator for adjusting the position of the intermediate covering element (66) depending on the monitored position.

7. The feed device according to claim 1, characterized in that the intermediate covering element (66) is designed to cover a first roller recess (13), a second roller recess (23) and in particular a third roller recess (33).

8. The feed device according to claim 1, characterized in that the intermediate covering element (66) has at least one additional roller recess (65) formed such that at least one of the upper roller elements (12, 22, 32) is movable within the additional roller recess (65) relative to the intermediate covering element (66) in the vertical direction (HR).

9. The feed device according to claim 1, characterized in that the intermediate covering element (66) and/or the at least one covering element (62, 64) are/is arranged in a transverse direction (QR) at a right angle to the feed direction (ER) between the feed channel (4) and the side wall (42).

10. The feed device according to claim 1, claims, characterized in that the intermediate covering element (66) is arranged in a transverse direction (QR) at a right angle to the feed direction (ER) between the at least one covering element (62, 64) and the feed channel (4).

11. The feed device according to claim 1, characterized in that the bearing arrangement (50) has a guide arrangement for guiding the intermediate covering element (66) in the vertical direction (HR), wherein the guide arrangement comprises at least one, in particular two, guide element(s) (67) arranged on the intermediate covering element (66) which guide element(s) 67) extend(s) into or through an intermediate covering element recess (63) in the side wall (42).

12. The feed device according to claim 1, characterized in that the bearing arrangement (50) for mounting the upper roller elements (12, 22, 32) has at least one first rocker element (52) on which the upper roller elements (12, 22, 32) are rotatably mounted and a second rocker element (54) which is arranged pivotably movably on the frame device (40) and pivotably movably about a rocker pivot axis (SA) on the first rocker element (52).

13. The feed device according to claim 1, characterized in that the covering apparatus (60) has a first covering element (62) for covering a first roller recess (13) and a second covering element (64) for covering a second roller recess (23) and in particular a third roller recess (33).

14. The feed device according to claim 1, characterized in that a conducting element (68) is arranged between the feed channel (4) and the at least one covering element (62, 64) and/or the intermediate covering element (66) and is arranged in a fixed position relative to the frame device (40), which conducting element extends between the upper roller elements (12, 22, 32) and the lower roller elements (14, 24, 34) in the feed direction (ER).

15. The feed device according to claim 1, characterized in that the conducting element (68) has a transverse conducting portion (69) at a feed channel inlet, which transverse conducting portion (69), facing away from the feed channel (4), projects at least partially in the transverse direction (QR) beyond the intermediate covering element (66), the at least one covering element (62, 64) and/or the side wall (42).

16. The feed device according to claim 1, characterized in that the intermediate covering element (66) and/or the conducting element (68) has at least one, in particular one per lower roller element (14, 24, 34), concave recess (70), within which at least a part of one of the lower roller elements (14, 24, 34) is arranged, at least in one position of the bearing arrangement (50).
